(19) United States
(12) Patent Application Publication
(10) Pub. No.: US 2022/0112108 A1
(43) Pub. Date: Apr. 14, 2022

(54) Hierarchical Model Predictive Control Method of Wastewater Treatment Process based on Fuzzy Neural Network

(71) Applicant: BEIJING UNIVERSITY OF TECHNOLOGY, BEIJING (CN)

(72) Inventors: Honggui HAN, BEIJING (CN); Shijia FU, BEIJING (CN); Xiaolong WU, BEIJING (CN); Junfei QIAO, BEIJING (CN)

(21) Appl. No.: 17/392,100

(22) Filed: Aug. 2, 2021

(30) Foreign Application Priority Data
Oct. 10, 2020 (CN) 202011080017.4

(51) Int. Cl. C02F 3/00; G06N 3/04; G05B 13/04; G05B 13/02

(52) U.S. Cl. CPC C02F 3/006; G06N 3/0436; G06N 3/0454; C02F 2209/001; G05B 13/0285; C02F 2209/22; C02F 2209/15; G05B 13/048

(57) ABSTRACT

A hierarchical model predictive control (HMPC) method based on fuzzy neural network for wastewater treatment process (WWTP) is designed to realize hierarchical control of dissolved oxygen (DO) concentration and nitrate nitrogen concentration. In view of the difference of time scales in WWTP, it is difficult to accurately control the concentration of DO and nitrate nitrogen. The disclosure establishes a HMPC structure according to different time scales. Then, the concentration of DO and nitrate nitrogen is controlled with different frequencies. It not only conforms to the operation characteristics of WWTP, but also solves the problem of poor operation performance of multivariable model predictive control. The experimental results show that the HMPC method can achieve accurate on-line control of DO concentration and nitrate nitrogen concentration with different time scales.

### CROSS-REFERENCE TO RELATED APPLICATION

This application claims priority to Chinese application No. 202011080017.4, filed on Oct. 10, 2020, the content of which is hereby incorporated by reference in its entirety.

Technology Area Since the control effect of DO concentration and nitrate nitrogen concentration directly affects the effluent quality and operation energy consumption of WWTP, the invention designs a FNN based HMPC method of WWTP to realize the online hierarchical control of DO concentration and nitrate nitrogen concentration. As an important part of WWTP, the control of DO concentration and nitrate nitrogen concentration is an important branch of advanced manufacturing technology, which belongs to the field of intelligent control and water treatment.

Technology Background Most countries and regions in the world are facing a serious shortage of water resources. Wastewater treatment is one of the important solutions to solve the shortage of water resources. It can not only reduce the discharge of water pollutants, but also produce renewable water sources to maintain the balance of ecological and natural material circulation.

The concentration of DO in aerobic zone of wastewater treatment unit directly affects the nitrification process. When the concentration of DO increases, the concentration of ammonia nitrogen and total nitrogen in the effluent will decrease, but when the concentration of DO reaches a certain value, the change range of ammonia nitrogen in the effluent will weaken. Nitrate concentration in anoxic zone of wastewater treatment unit is an important index to measure the effect of denitrification, which reflects the process of denitrification. Controlling nitrate concentration in a suitable range can improve the potential of denitrification. Therefore, it is very important to control the concentration of DO and nitrate nitrogen in the wastewater treatment unit. It is necessary to control the concentration of DO and nitrate nitrogen in a certain range in order to improve the effluent quality.

However, due to the complexity of physical, chemical and biological phenomena associated with the WWTP, as well as the sudden change of inflow flow, the control of WWTP is a very complex problem. Although the traditional PID control or nonlinear model predictive control is a widely used control method at present, due to the different time scales of the control variables in the WWTP, it may reduce the system performance and even destroy the stability of the closed-loop system.

The invention designs a HMPC method for WWTP based on FNN, and realizes online hierarchical control of DO concentration and nitrate nitrogen concentration in WWTP according to different time scales by constructing hierarchical model predictive control structure.

### SUMMARY

Aiming at the DO concentration and nitrate nitrogen concentration are difficult to accurately control caused by the characteristics of time scale difference in WWTP, the invention proposes a HMPC method for WWTP based on FNN. According to different time scales, the control method establishes a hierarchical model predictive control structure, and controls the DO concentration and nitrate concentration according to different frequency. The invention solves the problem of poor operation performance of current multivariable model predictive control, and effectively improves the accuracy of online control of DO concentration and nitrate nitrogen concentration;

The invention adopts the following technical scheme and implementation steps:

1. A hierarchical model predictive control (HMPC) system of wastewater treatment process (WWTP) based on fuzzy neural network (FNN) is proposed to solve the problem that control variables have different time scales. Then, the effect of wastewater treatment is improved by hierarchical control of dissolved oxygen (DO) concentration and nitrate nitrogen concentration, comprising the following steps:

(1) The HMPC system for WWTP control comprising a set of measuring means arranged to obtain a dataset, the dataset comprises a plurality of process variables related to a parameter of WWTP; a programmable logic controller (PLC) arranged to perform D/A conversion and A/D conversion; a variable-frequency drive (VFD) arranged to control the aeration pump and electronic valve by changing the working power frequency of motor; a HMPC module arranged to calculate the control law to track the DO concentration and nitrate nitrogen concentration in WWTP with different time scales; the HMPC module comprising a hierarchical structure, in which each layer contains a FNN to predict the system output and an optimization control module to calculate the control law;

(2) According to different time scales, the hierarchical control structure of HMPC module is designed to control the DO concentration and nitrate nitrogen concentration in WWTP:

The high-level controller consists of high-level FNN and high-level model predictive controller, it takes the sampling period of nitrate nitrogen concentration 2T as the time scale to track the set values of nitrate nitrogen concentration and DO concentration, and calculates the high-level control law, t₁=2mT is the sampling time of nitrate nitrogen concentration, and m is the sampling steps of nitrate nitrogen concentration; The low-level controller consists of low-level FNN and low-level model predictive controller, it takes the sampling period of DO concentration T as the time scale to track the set values of DO concentration and the control law calculated by high-level controller, and calculates the low-level control law, t₂=kT is the sampling time of DO concentration, and k is the sampling steps of DO concentration;

(3) The high-level FNN is designed to predict the concentration of nitrate nitrogen at each sampling time t₁, which is as follows:

1) Set q=1;

2) The input of the high-level FNN is x₁(t₁)=[y₁(t₁), u₂₁(t₁), u₂₂(t₁)]^{T}, y₁(t₁)=[y₁(t₁−1), y₁(t₁−2)], u₂₁(t₁)=[u₂₁(t₂−5), u₂₁(t₂−6)], u₂₂(t₁)=[u₂₂(t₂−5), u₂₂(t₂−6)], y₁(t₁−1) is the actual value of nitrate nitrogen concentration at t₁−1, y₁(t₁−2) is the actual value of nitrate nitrogen concentration at t₁−2, u₂₁(t₂−5) is the aeration rate at t₂−5, u₂₁(t₂−6) is the aeration rate at t₂−6, u₂₂(t₂−5) is the internal reflux in WWTP at t₂−5, u₂₂(t₂−6) is the internal reflux in WWTP at t₂−6, T is the transpose of matrix, the output of the high-level FNN is the predicted value of nitrate nitrogen concentration ŷ₁(t₁) at t₁, the output expression is as follows:

$${\hat{y}}_{1} ( {t}_{1} ) = \frac{{\sum }_{j = 1}^{8} {w}_{hj} ( {t}_{1} ) {e}^{- {{\sum }^{ }}_{i = 1}^{6} \frac{{( {x}_{1 i} ( {t}_{1} ) - {c}_{hij} ( {t}_{1} ) )}^{2}}{2 {σ}_{hij}^{2} ( {t}_{1} )}}}{{\sum }_{j = 1}^{8} {e}^{- {{\sum }^{ }}_{i = 1}^{6} \frac{{( {x}_{1 i} ( {t}_{1} ) - {c}_{hij} ( {t}_{1} ) )}^{2}}{2 {σ}_{hij}^{2} ( {t}_{1} )}}} , \qquad ( 1 )$$

where x₁ᵢ(t₁) is the ith input of the high-level FNN at t₁, wₕⱼ(t₁) is the connection weight between the jth neuron in the rule layer and the output neuron at t₁, j∈[1, 8], cₕᵢⱼ(t₁) is the center value of the jth radial basal neuron corresponding to the ith input neuron at t₁, i∈[1, 6], σₕᵢⱼ(t₁) is the center width of the ith input neuron corresponding to the jth radial basal neuron at t₁, e=2.72, the parameter update rules are as follows:

wₕⱼ(tᵢ+1)=wₕⱼ(t₁)−0.2∂E₁(t₁)/∂wₕⱼ(t₁),

cₕᵢⱼ(t₁+1)=cₕᵢⱼ(t₁)−0.2∂E₁((t₁)/∂cₕᵢⱼ(t₁),

σₕᵢⱼ(t₁+1)=σₕᵢⱼ(t₁)−0.2∂E₁(t₁)/∂σₕᵢⱼ(t₁), (2)

where wₕⱼ(t₁+1) is the connection weight between the jth neuron in the rule layer and the output neuron at t₁+1, cₕᵢⱼ(t₁+1) is the center value of the jth radial basal neuron corresponding to the ith input neuron at t₁+1, σₕᵢⱼ(t₁+1) is the center width of the ith input neuron corresponding to the jth radial basal neuron at t₁+1, E₁(t₁)=½[y₁(t₁)−ŷ₁(t₁)]² is the error between the actual and predicted nitrate nitrogen concentration at t₁;

3) Set q=q+1, if q≤20 is true, go to step 2), otherwise, exit the cycle;

(4) The low-level FNN is designed to predict the DO concentration at each sampling time t₂, which is as follows:

I Set r=1;

II The input of the low-level FNN is x₂(t₂)=[y₂(t₂), u₂₁(t₂), u₂₂(t₂)]^{T}, y₂(t₂)=[y₂(t₂−1), y₂(t₂−2)], u₂₁(t₂)=[u₂₁(t₂−5), u₂₁(t₂−6)], u₂₂(t₂)=[u₂₂(t₂−5), u₂₂(t₂−6)], y₂(t₂−1) is the actual value of DO concentration at t₂−1, y₂(t₂−2) is the actual value of DO concentration at t₂−2, the output of the low-level FNN if the predicted value of DO concentration y₂(t₂) at t₂, the output expression is as follows:

$${\hat{y}}_{2} ( {t}_{2} ) = \frac{{\sum }_{j = 1}^{8} {w}_{lj} ( {t}_{2} ) {e}^{- {{\sum }^{ }}_{i = 1}^{6} \frac{{( {x}_{2 i} ( {t}_{2} ) - {c}_{lij} ( {t}_{2} ) )}^{2}}{2 {σ}_{lij}^{2} ( {t}_{2} )}}}{{\sum }_{j = 1}^{8} {e}^{- {{\sum }^{ }}_{i = 1}^{6} \frac{{( {x}_{2 i} ( {t}_{2} ) - {c}_{lij} ( {t}_{2} ) )}^{2}}{2 {σ}_{lij}^{2} ( {t}_{2} )}}} , \qquad ( 3 )$$

where x₂ᵢ(t₂) is the ith input of the low-level FNN at t₂, wₗⱼ(t₂) is the connection weight between the jth neuron in the rule layer and the output neuron at t₂, j∈[1, 8], cₗᵢⱼ(t₂) is the center value of the jth radial basal neuron corresponding to the ith input neuron at t₂, i∈[1, 6], σₗᵢⱼ(t₂) is the center width of the ith input neuron corresponding to the jth radial basal neuron at t₂, the parameter update rules are as follows:

wₗⱼ(t₂+1)=wₗⱼ(t₂)−0.2∂E₂(t₂)/∂wₗⱼ(t₂),

cₗᵢⱼ(t₂+1)=cₗᵢⱼ(t₂)−0.2∂E₂(t₂)/∂cₗᵢⱼ(t₂),

σₗᵢⱼ(t₂+1)=σₗᵢⱼ(t₂)−0.2∂E₂(t₂)/∂σₗᵢⱼ(t₂), (4)

where wₗⱼ(t₂+1) is the connection weight between the jth neuron in the rule layer and the output neuron at t₂+1, cₗᵢⱼ(t₂+1) is the center value of the jth radial basal neuron corresponding to the ith input neuron at t₂+1, σₗᵢⱼ(t₂+1) is the center width of the ith input neuron corresponding to the jth radial basal neuron at t₂+1, E₂(t₂)=½[y₂(t₂)−ŷ₂(t₂)]², is the error between the actual and predicted DO concentration at t₂;

III Set r=r+1, if r≤20 is true, go to step II, otherwise, exit the cycle;

(5) The optimization control module of HMPC module is designed as follows:

\textcircled{1} Set k=0, m=0;

\textcircled{2} According to Eq.(1) and Eq.(3), the outputs of the high-level FNN ŷ₁(t₁) and the low-level FNN ŷ₂(t₂) are calculated respectively, ŷ₁(t₁)=[ŷ₁(t₁+1), ŷ₁(t₁+2), ŷ₁(t₁+5)]^{T}, ŷ₂(t₂)=[ŷ₂(t₂+1), ŷ₂(t₂+2), . . . , ŷ₂(t₂+5)]^{T}, ŷ₁(t₁+1) is the predicted value of nitrate nitrogen concentration at t₁+1, ŷ₁(t₁+2) is the predicted value of nitrate nitrogen concentration at t₁+2, ŷ₁(t₁+5) is the predicted value of nitrate nitrogen concentration at t₁+5, ŷ₂(t₂+1) is the predicted value of DO concentration at t₂+1, ŷ₂(t₂+2) is the predicted value of DO concentration at t₂+2, ŷ₂(t₂+5) is the predicted value of DO concentration at t₂+5;

\textcircled{3} The objective function of high-level MPC is designed to track the set value of nitrate nitrogen concentration and DO concentration, and the high-level law at t₁ is calculated:

J₁(t₁)=λ₁[α₁eₚ₁(t₁)+ρ₁Δu₁(t₁)^{T}Δu₁(t₁)]+λ₂[α₂eₚ₂(t₂)^{T}eₚ₂(t₂)+ρ₂Δu₁(t₁)^{T}Δu₁(t₁)], (5)

where eₚ₁(t₁)=r₁(t₁)−ŷ₁(t₁) is the error vector between the set value of nitrate nitrogen concentration at t₁ and the predicted value of nitrate nitrogen concentration, eₚ₁(t₁)=[eₚ₁(t₁+1), eₚ₁(t₁+2), . . . , eₚ₁(t₁+5)]^{T}, r₁(t₁)=[r₁(t₁+1), r₁(t₁+2), . . . , r₁(t₁+5)]^{T}, eₚ₁(t₁+1) is the error between the set value of nitrate nitrogen concentration and the predicted value of nitrate nitrogen concentration at t₁+1, eₚ₁(t₁+2) is the error between the set value of nitrate nitrogen concentration and the predicted value of nitrate nitrogen concentration at t₁+2, eₚ₁(t₁+5) is the error between the set value of nitrate nitrogen concentration and the predicted value of nitrate nitrogen concentration at t₁+5, r₁(t₁+1) is the set value of nitrate nitrogen concentration at t₁+1, r₁(t₁+2) is the set value of nitrate nitrogen concentration at t₁+2, r₁(t₁+5) is the set value of nitrate nitrogen concentration at t₁+5, eₚ₂(t₂)=r₂(t₂)−ŷ₂(t₂) is the error vector between the set value of DO concentration at t₂ and the predicted value of DO concentration, eₚ₂(t₂)=[eₚ₂(t₂+1), eₚ₂(t₂+2), eₚ₂(t₂+5)]^{T}, r₂(t₂)=[r₂(t₂+1), r₂(t₂+2), . . . , r₂(t₂+5)]^{T}, eₚ₂(t₂+1) is the error between the set value of DO concentration and the predicted value of DO concentration at t₂+1, eₚ₂(t₂+2) is the error between the set value of DO concentration and the predicted value of DO concentration at t₂+2, eₚ₂(t₂+5) is the error between the set value of DO concentration and the predicted value of DO concentration at t₂+5, r₂(t₂+1) is the set value of DO concentration at t₂+1, r₂(t₂+2) is the set value of DO concentration at t₂+2, r₂(t₂+5) is the set value of DO concentration at t₂+5, Δu₁(t₁)=[Δu₁₁(t₁), Δu₁₂(t₁)]^{T} is the control vector adjustment amount at t₁, Δu₁₁(t₁) is the adjustment amount of blower aeration at t₁, Δu₁₂(t₁) is the adjustment amount of internal reflux at t₁, λ₁=0.5, λ₂=0.5 are weight parameters, α₁=30, ρ₁=10, α₂=0.5, ρ₂=0.5 are control parameters, where

Δu₁(t₁)=u₁(t₁+1)−u₁(t₁),

∥Δu₁(t₁)|≤Δuₘₐₓ, (6)

u₁(t₁)=[u₁₁(t₁), u₁₂(t₁)]^{T} is the control vector at t₁, u₁₁(t₁) is the aeration rate of the blower at t₁, u₁₂(t₁) is the internal reflux at t₁, u₁(t₁+1)=[u₁₁(t₁+1), u₁₂(t₁+1)]^{T} is the control vector at t₁+1, u₁₁(t₁+1) is the aeration rate of the blower at t₁+1, u₁₂(t₁+1) is the internal reflux flow at t₁+1, Δuₘₐₓ=[ΔK_{L}aₘₐₓ, ΔQₐₘₐₓ]^{T} is the maximum adjustment vector allowed by the controller, ΔK_{L}aₘₐₓ is the maximum aeration adjustment amount, ΔQₐₘₐₓ is the maximum internal reflux adjustment amount, Δuₘₐₓ is set through the blower and internal reflux valve in the control system equipment;

The aeration rate and internal reflux adjustment vector of the high-level MPC are calculated by minimizing Eq.(5):

$$Δ {u}_{1} ( {t}_{1} ) = {η}_{1} ( {{ξ}_{1} ( \frac{\partial {\hat{y}}_{1} ( {t}_{1} )}{\partial {u}_{1} ( {t}_{1} )} )}^{T} {e}_{p 1} ( {t}_{1} ) + {{ξ}_{2} ( \frac{\partial {\hat{y}}_{2} ( {t}_{2} )}{\partial {u}_{1} ( {t}_{1} )} )}^{T} {e}_{p 2} ( {t}_{2} ) ) , \qquad ( 7 )$$

where η₁=0.8, ξ₁=3, ξ₂=1 are control parameters to adjust the aeration rate and internal reflux at t₁:

u₁(t₁+1)=u₁(t₁)+Δu₁(t₁), (8)

\textcircled{4} The objective function of the low-level MPC is designed to track the concentration of DO and the control law calculated by high-level controller, and the low-level control law is calculated at t₂;

J₂(t₂)=γ₁eₚ₂(t₂)²+γ₂[u₂₂(t₂)−u₁₂(t₁)]²+γ₃Δu₂(t₂)^{T}Δu₂(t₂), (9)

where u₂₂(t₂) is the internal reflux of the low-level MPC at t₂, u₁₂(t₁) is the internal reflux calculated by the high-level controller at t₁, Δu₂(t₂)=[Δu₂₁(t₂), Δu₂₂(t₂)]^{T} is the control vector adjustment amount at t₂, Δu₂₁(t₂) is the blower aeration adjustment amount at t₂, Δu₂₂(t₂) is the internal reflux adjustment amount at t₂, γ₁=30, γ₂=10, γ₃=1 are control parameters, where

Δu₂(t₂)=u₂(t₂+1)−u₂(t₂),

|Δu₂(t₂)|≤Δuₘₐₓ, (10)

where u₂(t₂)=[u₂₁(t₂), u₂₂(t₂)]^{T} is the control vector at t₂, u₂₁(t₂) is the aeration rate of the blower at t₂, u₂₂(t₂) is the internal reflux flow at t₂, u₂(t₂+1)=[u₂ (t₂+1), u₂₂(t₂+1)]^{T} is the control vector at t₂+1, u₂₁(t₂+1) is the aeration rate of the blower at t₂+1, u₂₁(t₂+1) is the internal reflux flow at t₂+1;

The aeration rate and internal reflux adjustment vector of the low-level MPC are calculated by minimizing Eq.(9):

$$Δ {u}_{2} ( {t}_{2} ) = {η}_{2} [ {{γ}_{1} ( \frac{\partial {\hat{y}}_{2} ( {t}_{2} )}{\partial {u}_{2} ( {t}_{2} )} )}^{T} {e}_{p 2} ( {t}_{2} ) - {{γ}_{2} ( \frac{\partial {u}_{22} ( {t}_{2} )}{\partial {u}_{2} ( {t}_{2} )} )}^{T} ( {u}_{22} ( {t}_{2} ) - {u}_{12} ( {t}_{1} ) ) ] , \qquad ( 11 )$$

where η₂=8.4 is control parameter to adjust the aeration rate and internal reflux at t₂:

u₂(t₂+1)=u₂(t₂)+Δu₂(t₂), (12)

\textcircled{5} Set k=k+1, if k=2(m+1) is true, set m=m+1 and go to step \textcircled{2}, otherwise, go to step \textcircled{6};

\textcircled{6} If k≤200 is true, calculate the output of the low-level FNN ŷ₂(t₂)=[ŷ₂(t₂+1), ŷ₂(t₂+2), . . . , ŷ₂(t₂+5)]^{T} by Eq.(3), and go to step \textcircled{4}, otherwise, end the cycle;

(6) The concentration of nitrate nitrogen and DO is controlled by u₂(t₂) solved by the low-level controller, u₂(t₂)=[u₂₁(t₂), u₂₂(t₂)]^{T} is the input of inverter and sensor at t₂, the inverter controls the blower by adjusting the speed of motor, and the sensor controls the valve by adjusting the opening of instrument, then, the aeration rate and internal reflux are controlled, the output of the system is the actual value of nitrate nitrogen concentration and DO concentration.

The Novelties of this Patent Contain:

(1) To deal with the strong nonlinearity of WWTP, two FNNs are designed to model the concentration of DO and nitrate nitrogen, which solves the problem that the nonlinear system is difficult to model.

(2) Aiming at the problem that the control variables of WWTP have different time scales, a hierarchical model predictive control structure is established to control the concentration of DO and nitrate nitrogen according to different frequency.

(3) Due to the strong coupling of WWTP, the relationship between the high-level controller and the low-level controller is established. The low-level controller tracks the DO concentration and the control law calculated by the high-level controller.

(4) The invention designs a hierarchical optimization algorithm to solve the above hierarchical optimization problems, so as to calculate the control law.

(5) The hierarchical model predictive control method based on FNN proposed in this invention has the characteristics of high precision, low energy consumption, strong stability, etc.

Attention: for convenience of description, the invention only adopt the control of DO concentration and nitrate nitrogen concentration. The invention can also be used for the control of ammonia nitrogen in WWTP, etc. As long as the principle of the invention is adopted for control, it shall be the scope of the invention.

### DESCRIPTION OF DRAWINGS

FIG. 1 is diagram of the HMPC system of WWTP.

FIG. 2 is a control structure diagram of the invention.

FIG. 3 is the result diagram of the DO concentration control in this invention.

FIG. 4 is the error diagram of the DO concentration control result in this invention.

FIG. 5 is the result diagram of nitrate nitrogen concentration control in this invention.

FIG. 6 is the error diagram of the nitrate nitrogen concentration control result in this invention.

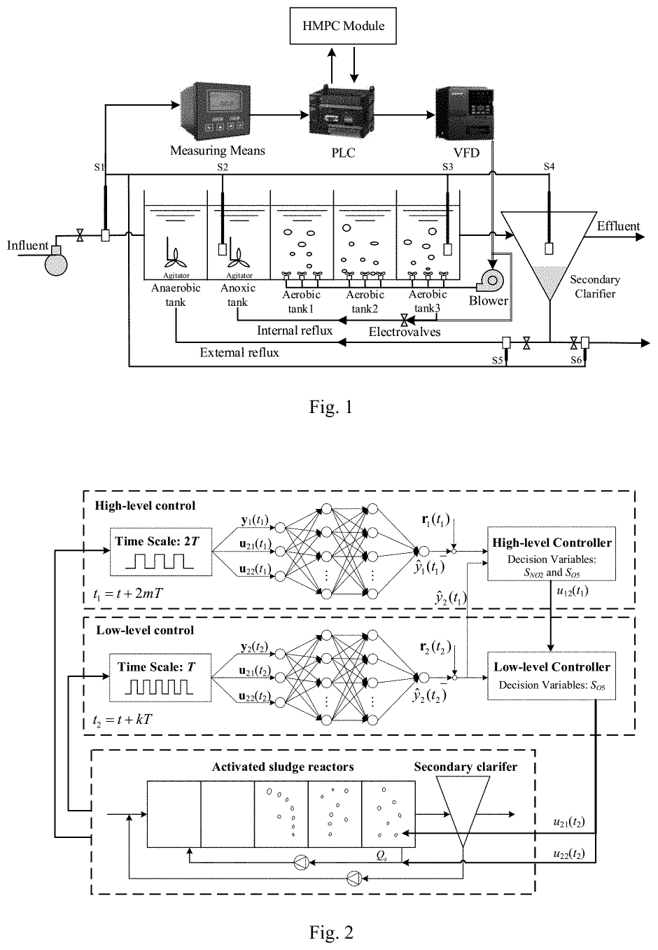

### DETAILED DESCRIPTION OF THE INVENTION

1. A hierarchical model predictive control (HMPC) system of wastewater treatment process (WWTP) based on fuzzy neural network (FNN) is proposed to solve the problem that control variables have different time scales. Then, the effect of wastewater treatment is improved by hierarchical control of dissolved oxygen (DO) concentration and nitrate nitrogen concentration, comprising the following steps:

(1) The HMPC system for WWTP control comprising a set of measuring means arranged to obtain a dataset, the dataset comprises a plurality of process variables related to a parameter of WWTP; a programmable logic controller (PLC) arranged to perform D/A conversion and A/D conversion; a variable-frequency drive (VFD) arranged to control the aeration pump and electronic valve by changing the working power frequency of motor; a HMPC module arranged to calculate the control law to track the DO concentration and nitrate nitrogen concentration in WWTP with different time scales; the HMPC module comprising a hierarchical structure, in which each layer contains a FNN to predict the system output and an optimization control module to calculate the control law;

(2) According to different time scales, the hierarchical control structure of HMPC module is designed to control the DO concentration and nitrate nitrogen concentration in WWTP:

The high-level controller consists of high-level FNN and high-level model predictive controller, it takes the sampling period of nitrate nitrogen concentration 2T as the time scale to track the set values of nitrate nitrogen concentration and DO concentration, and calculates the high-level control law, t₁=2mT is the sampling time of nitrate nitrogen concentration, and m is the sampling steps of nitrate nitrogen concentration;

The low-level controller consists of low-level FNN and low-level model predictive controller, it takes the sampling period of DO concentration T as the time scale to track the set values of DO concentration and the control law calculated by high-level controller, and calculates the low-level control law, t₂=kT is the sampling time of DO concentration, and k is the sampling steps of DO concentration;

(3) The high-level FNN is designed to predict the concentration of nitrate nitrogen at each sampling time t₁, which is as follows:

1) Set q=1;

2) The input of the high-level FNN is x₁(t₁)=[y₁(t₁), u₂₁(t₁), u₂₂(t₁)]^{T}, y₁(t₁)=[y₁(t₁−1), y₁(t₁−2)], u₂₁(t₁)=[u₂₁(t₂−5), u₂₁(t₂−6)], u₂₂(t₁)=[u₂₂(t₂−5), u₂₂(t₂−6)], y₁(t₁−1) is the actual value of nitrate nitrogen concentration at t₁−1, y₁(t₁−2) is the actual value of nitrate nitrogen concentration at t₁−2, u₂₁(t₂−5) is the aeration rate at t₂−5, u₂₁(t₂−6) is the aeration rate at t₂−6, u₂₂(t₂−5) is the internal reflux in WWTP at t₂−5, u₂₂(t₂−6) is the internal reflux in WWTP at t₂−6, T is the transpose of matrix, the output of the high-level FNN is the predicted value of nitrate nitrogen concentration ŷ₁(t₁) at t₁, the output expression is as follows:

$${\hat{y}}_{1} ( {t}_{1} ) = \frac{{\sum }_{j = 1}^{8} {w}_{hj} ( {t}_{1} ) {e}^{- {{\sum }^{ }}_{i = 1}^{6} \frac{{( {x}_{1 i} ( {t}_{1} ) - {c}_{hij} ( {t}_{1} ) )}^{2}}{2 {σ}_{hij}^{2} ( {t}_{1} )}}}{{\sum }_{j = 1}^{8} {e}^{- {{\sum }^{ }}_{i = 1}^{6} \frac{{( {x}_{1 i} ( {t}_{1} ) - {c}_{hij} ( {t}_{1} ) )}^{2}}{2 {σ}_{hij}^{2} ( {t}_{1} )}}} , \qquad ( 13 )$$

where x₁ᵢ(t₁) is the ith input of the high-level FNN at t₁, wₕⱼ(t₁) is the connection weight between the jth neuron in the rule layer and the output neuron at t₁, j∈[1, 8], cₕᵢⱼ(t₁) is the center value of the jth radial basal neuron corresponding to the ith input neuron at t₁, i∈[1, 6], σₕᵢⱼ(t₁) is the center width of the ith input neuron corresponding to the jth radial basal neuron at t₁, e=2.72, the parameter update rules are as follows:

wₕⱼ(t₁+1)=wₕⱼ(t₁)−0.2∂E₁(t₁)/∂wₕⱼ(t₁),

cₕᵢⱼ(t₁+1)=cₕᵢⱼ(t₁)−0.2∂E₁(t₁)/∂cₕᵢⱼ(t₁),

σₕᵢⱼ(t₁+1)=σₕᵢⱼ(t₁)−0.2∂E₁(t₁)/∂σₕᵢⱼ(t₁) (14)

where wₕⱼ(t₁+1) is the connection weight between the jth neuron in the rule layer and the output neuron at t₁+1, cₕᵢⱼ(t₁+1) is the center value of the jth radial basal neuron corresponding to the ith input neuron at t₁+1, σₕᵢⱼ(t₁+1) is the center width of the ith input neuron corresponding to the jth radial basal neuron at t₁+1, E₁(t₁)=½[y₁(t₁)−ŷ₁(t₁)]² is the error between the actual and predicted nitrate nitrogen concentration at t₁;

3) Set q=q+1, if q≤20 is true, go to step 2), otherwise, exit the cycle;

(4) The low-level FNN is designed to predict the DO concentration at each sampling time t₂, which is as follows:

I Set r=1;

II The input of the low-level FNN is x₂(t₂)=[y₂(t₂), u₂₁(t₂), u₂₂(t₂)]^{T}, y₂(t₂)=[y₂(t₂−1), y₂(t₂−2)], u₂₁(t₂)=[u₂₁(t₂−5), u₂₁(t₂−6)], u₂₂(t₂)=[u₂₂(t₂−5), u₂₂(t₂−6)], y₂(t₂−1) is the actual value of DO concentration at t₂−1, y₂(t₂−2) is the actual value of DO concentration at t₂−2, the output of the low-level FNN if the predicted value of DO concentration ŷ₂(t₂) at t₂, the output expression is as follows:

$${\hat{y}}_{2} ( {t}_{2} ) = \frac{{\sum }_{j = 1}^{8} {w}_{lj} ( {t}_{2} ) {e}^{- {{\sum }^{ }}_{i = 1}^{6} \frac{{( {x}_{2 i} ( {t}_{2} ) - {c}_{lij} ( {t}_{2} ) )}^{2}}{2 {σ}_{lij}^{2} ( {t}_{2} )}}}{{\sum }_{j = 1}^{8} {e}^{- {{\sum }^{ }}_{i = 1}^{6} \frac{{( {x}_{2 i} ( {t}_{2} ) - {c}_{lij} ( {t}_{2} ) )}^{2}}{2 {σ}_{lij}^{2} ( {t}_{2} )}}} , \qquad ( 15 )$$

where x₂ᵢ(t₂) is the ith input of the low-level FNN at t₂, wₗⱼ(t₂) is the connection weight between the jth neuron in the rule layer and the output neuron at t₂, j∈[1, 8], cₗᵢⱼ(t₂) is the center value of the jth radial basal neuron corresponding to the ith input neuron at t₂, i∈[1, 6], σₗᵢⱼ(t₂) is the center width of the ith input neuron corresponding to the jth radial basal neuron at t₂, the parameter update rules are as follows:

wₗⱼ(t₂+1)=wₗⱼ(t₂)−0.2∂E₂(t₂)/∂wₗⱼ(t₂),

cₗᵢⱼ(t₂+1)=cₗᵢⱼ(t₂)−0.2∂E₂(t₂)/∂cₗᵢⱼ(t₂),

σₗᵢⱼ(t₂+1)=σₗᵢⱼ(t₂)−0.2∂E₂(t₂)/∂σₗᵢⱼ(t₂), (16)

where wₗⱼ(t₂+1) is the connection weight between the jth neuron in the rule layer and the output neuron at t₂+1, cₗᵢⱼ(t₂+1) is the center value of the jth radial basal neuron corresponding to the ith input neuron at t₂+1, σₗᵢⱼ(t₂+1) is the center width of the ith input neuron corresponding to the jth radial basal neuron at t₂+1, E₂(t₂)=½[y₂(t₂)−ŷ₂(t₂)]², is the error between the actual and predicted DO concentration at t₂;

III Set r=r+1, if r≤20 is true, go to step II, otherwise, exit the cycle;

(5) The optimization control module of HMPC module is designed as follows:

\textcircled{1} Set k=0, m=0;

\textcircled{2} According to Eq.(1) and Eq.(3), the outputs of the high-level FNN ŷ₁(t₁) and the low-level FNN ŷ₂(t₂) are calculated respectively, ŷ₁(t₁)=[ŷ₁(t₁+1), ŷ₁(t₁+2), . . . , ŷ₁(t₁+5)]^{T}, ŷ₂(t₂)=[ŷ₂(t₂+1), ŷ₂(t₂+2), . . . , ŷ₂(t₂+5)]^{T}, ŷ₁(t₁+1) is the predicted value of nitrate nitrogen concentration at t₁+1, ŷ₁(t₁+2) is the predicted value of nitrate nitrogen concentration at t₁+2, ŷ₁(t₁+5) is the predicted value of nitrate nitrogen concentration at t₁+5, ŷ₂(t₂+1) is the predicted value of DO concentration at t₂+1, ŷ₂(t₂+2) is the predicted value of DO concentration at t₂+2, ŷ₂(t₂+5) is the predicted value of DO concentration at t₂+5;

\textcircled{3} The objective function of high-level MPC is designed to track the set value of nitrate nitrogen concentration and DO concentration, and the high-level law at t₁ is calculated:

J₁(t₁)=λ₁[α₁eₚ₁(t₁)^{T}eₚ₁(t₁)+ρ₁Δu₁(t₁)^{T}Δu₁(t₁)]+λ₂[α₂eₚ₂(t₂)^{T}eₚ₂(t₂)+ρ₂Δu₁(t₁)^{T}Δu₁(t₁)], (17)

where eₚ₁(t₁)=r₁(t₁)−ŷ₁(t₁) is the error vector between the set value of nitrate nitrogen concentration at t₁ and the predicted value of nitrate nitrogen concentration, eₚ₁(t₁)=[eₚ₁(t₁+1), eₚ₁(t₁+2), . . . , eₚ₁(t₁+5)]^{T}, r₁(t₁)=[r₁(t₁+1), r₁(t₁+2), . . . , r₁(t₁+5)]^{T}, eₚ₁(t₁+1) is the error between the set value of nitrate nitrogen concentration and the predicted value of nitrate nitrogen concentration at t₁+1, eₚ₁(t₁+2) is the error between the set value of nitrate nitrogen concentration and the predicted value of nitrate nitrogen concentration at t₁+2, eₚ₁(t₁+5) is the error between the set value of nitrate nitrogen concentration and the predicted value of nitrate nitrogen concentration at t₁+5, r₁(t₁+1) is the set value of nitrate nitrogen concentration at t₁+1, r₁(t₁+2) is the set value of nitrate nitrogen concentration at t₁+2, r₁(t₁+5) is the set value of nitrate nitrogen concentration at t₁+5, eₚ₂(t₂)=r₂(t₂)−ŷ₂(t₂) is the error vector between the set value of DO concentration at t₂ and the predicted value of DO concentration, eₚ₂(t₂)=[eₚ₂(t₂+1), eₚ₂(t₂+2), . . . , eₚ₂(t₂+5)]^{T}, r₂(t₂)=[r₂(t₂+1), r₂(t₂+2), . . . , r₂(t₂+5)]^{T}, eₚ₂(t₂+1) is the error between the set value of DO concentration and the predicted value of DO concentration at t₂+1, eₚ₂(t₂+2) is the error between the set value of DO concentration and the predicted value of DO concentration at t₂+2, eₚ₂(t₂+5) is the error between the set value of DO concentration and the predicted value of DO concentration at t₂+5, r₂(t₂+1) is the set value of DO concentration at t₂+1, r₂(t₂+2) is the set value of DO concentration at t₂+2, r₂(t₂+5) is the set value of DO concentration at t₂+5, Δu₁(t₁)=[Δu₁₁(t₁), Δu₁₂(t₁)]^{T} is the control vector adjustment amount at t₁, Δu₁₁(t₁) is the adjustment amount of blower aeration at t₁, Δu₁₂(t₁) is the adjustment amount of internal reflux at t₁, λ₁=0.5, λ₂=0.5 are weight parameters, α₁=30, ρ₁=10, α₂=0.5, ρ₂=0.5 are control parameters, where

Δu₁(t₁)=u₁(t₁+1)−u₁(t₁),

|Δu₁(t₁)|≤Δuₘₐₓ, (18)

u₁(t₁)=[u₁₁(t₁), u₁₂(t₁)]^{T} is the control vector at t₁, u₁₁(t₁) is the aeration rate of the blower at t₁, u₁₂(t₁) is the internal reflux at t₁, u₁(t₁+1)=[u₁₁(t₁+1), u₁₂(t₁+1)]^{T} is the control vector at t₁+1, u₁₁(t₁+1) is the aeration rate of the blower at t₁+1, u₁₂(t₁+1) is the internal reflux flow at t₁+1, Δuₘₐₓ=[ΔK_{L}aₘₐₓ, ΔQₐₘₐₓ]^{T} is the maximum adjustment vector allowed by the controller, ΔK_{L}aₘₐₓ is the maximum aeration adjustment amount, ΔQₐₘₐₓ is the maximum internal reflux adjustment amount, Δuₘₐₓ is set through the blower and internal reflux valve in the control system equipment;

The aeration rate and internal reflux adjustment vector of the high-level MPC are calculated by minimizing Eq.(5):

$$Δ {u}_{1} ( {t}_{1} ) = {η}_{1} ( {{ξ}_{1} ( \frac{\partial {\hat{y}}_{1} ( {t}_{1} )}{\partial {u}_{1} ( {t}_{1} )} )}^{T} {e}_{p 1} ( {t}_{1} ) + {{ξ}_{2} ( \frac{\partial {\hat{y}}_{2} ( {t}_{2} )}{\partial {u}_{1} ( {t}_{1} )} )}^{T} {e}_{p 2} ( {t}_{2} ) ) , \qquad ( 19 )$$

where η₁=0.8, ξ₁=3, ξ₂=1 are control parameters to adjust the aeration rate and internal reflux at t₁:

u₁(t₁+1)=u₁(t₁)+Δu₁(t₁), (20)

\textcircled{4} The objective function of the low-level MPC is designed to track the concentration of DO and the control law calculated by high-level controller, and the low-level control law is calculated at t₂;

J₂(t₂)=γ₁eₚ₂(t₂)²+γ₂[u₂₂(t₂)−u₁₂(t₁)]²+γ₃Δu₂(t₂)^{T}Δu₂(t₂), (21)

where u₂₂(t₂) is the internal reflux of the low-level MPC at t₂, u₁₂(t₁) is the internal reflux calculated by the high-level controller at t₁, Δu₂(t₂)=[Δu₂₁(t₂), Δu₂₂(t₂)]^{T} is the control vector adjustment amount at t₂, Δu₂₁(t₂) is the blower aeration adjustment amount at t₂, Δu₂₂(t₂) is the internal reflux adjustment amount at t₂, γ₁=30, γ₂=10, γ₃=1 are control parameters, where

Δu₂(t₂)=u₂(t₂+1)−u₂(t₂),

|Δu₂(t₂)|≤Δuₘₐₓ, (22)

where u₂(t₂)=[u₂₁(t₂), u₂₂(t₂)]^{T} is the control vector at t₂, u₂₁(t₂) is the aeration rate of the blower at t₂, u₂₂(t₂) is the internal reflux flow at t₂, u₂(t₂+1)=[u₂₁(t₂+1), u₂₂(t₂+1)]^{T} is the control vector at t₂+1, u₂₁(t₂+1) is the aeration rate of the blower at t₂+1, u₂₁(t₂+1) is the internal reflux flow at t₂+1;

The aeration rate and internal reflux adjustment vector of the low-level MPC are calculated by minimizing Eq.(9):

$$Δ {u}_{2} ( {t}_{2} ) = {η}_{2} [ {{γ}_{1} ( \frac{\partial {\hat{y}}_{2} ( {t}_{2} )}{\partial {u}_{2} ( {t}_{2} )} )}^{T} {e}_{p 2} ( {t}_{2} ) - {{γ}_{2} ( \frac{\partial {u}_{22} ( {t}_{2} )}{\partial {u}_{2} ( {t}_{2} )} )}^{T} ( {u}_{22} ( {t}_{2} ) - {u}_{12} ( {t}_{1} ) ) ] , \qquad ( 23 )$$

where η₂=8.4 is control parameter to adjust the aeration rate and internal reflux at t₂:

u₂(t₂+1)=u₂(t₂)+Δu₂(t₂), (24)

\textcircled{5} Set k=k+1, if k=2(m+1) is true, set m=m+1 and go to step \textcircled{2}, otherwise, go to step \textcircled{6};

\textcircled{6} If k≤200 is true, calculate the output of the low-level FNN ŷ₂(t₂)=[ŷ₂(t₂+1), ŷ₂(t₂+2), . . . , ŷ₂(t₂+5)]^{T} by Eq.(3), and go to step \textcircled{4}, otherwise, end the cycle;

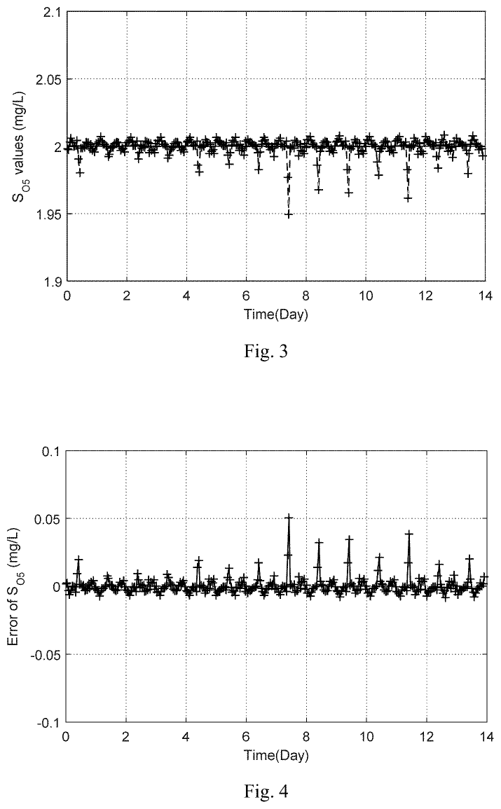

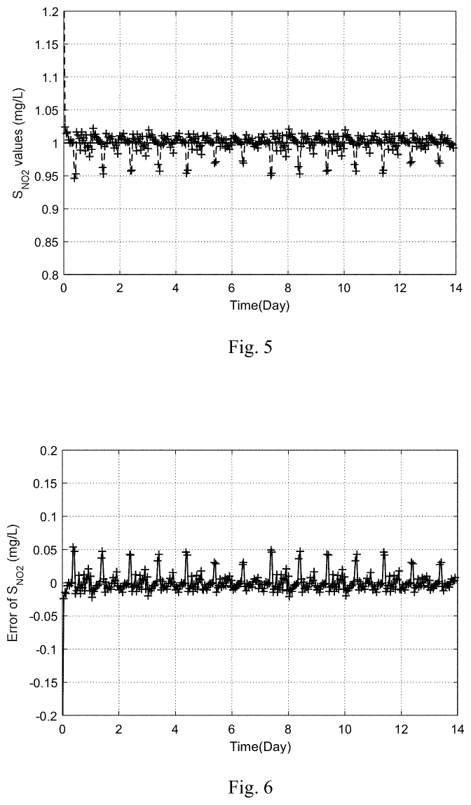

(6) The concentration of nitrate nitrogen and DO is controlled by u₂(t₂) solved by the low-level controller, u₂(t₂)=[u₂₁(t₂), u₂₂(t₂)]^{T} is the input of inverter and sensor at t₂, the inverter controls the blower by adjusting the speed of motor, and the sensor controls the valve by adjusting the opening of instrument, then, the aeration rate and internal reflux are controlled, the output of the system is the actual value of nitrate nitrogen concentration and DO concentration. FIG. 3 shows the DO concentration of the system, X-axis: time, unit: day, Y-axis: DO concentration, unit: mg/L, the solid line is the expected DO concentration, the dotted line is the actual DO concentration; the error between the actual output DO concentration and the expected DO concentration is shown in FIG. 4, X-axis: time, unit: day, Y-axis: DO concentration error, unit: mg/L FIG. 5 shows the nitrate concentration value of the system, X-axis: time, unit: day, Y-axis: nitrate concentration value, unit: mg/L, solid line is expected nitrate concentration value, dotted line is actual nitrate concentration value; the error between actual output nitrate concentration and expected nitrate concentration is shown in FIG. 6, X-axis: time, unit: day, Y-axis: nitrate concentration error value, unit: mg/L. The results show that the method is effective.

What is claimed is:

1. A hierarchical model predictive control (HMPC) method of wastewater treatment process (WWTP) based on fuzzy neural network (FNN), comprising the following steps:
(1) according to different time scales, a hierarchical control structure of HMPC module is designed to control dissolved oxygen (DO) concentration and nitrate nitrogen concentration in WWTP:
a high-level controller comprises high-level FNN and high-level model predictive controller, sampling period of nitrate nitrogen concentration 2T being taken as time scale to track set values of nitrate nitrogen concentration and DO concentration, and calculates a high-level control law, t₁=2mT is a sampling time of nitrate nitrogen concentration, and m is sampling steps of nitrate nitrogen concentration;
a low-level controller comprises low-level FNN and low-level model predictive controller, sampling period of DO concentration T being taken as time scale to track set values of DO concentration and the high-level control law calculated by the high-level controller, and calculates a low-level control law, t₂=kT is sampling time of DO concentration, and k is sampling steps of DO concentration;
(3) the high-level FNN is designed to predict a concentration of nitrate nitrogen at each sampling time t₁, which is as follows:
1) set q=1;
2) an input of the high-level FNN is x₁(t₁)=[y₁(t₁), u₂₁(t₁), u₂₂(t₁)]^{T}, y₁(t₁)=[y₁(t₁−1), y₁(t₁−2)], t₂₁(t₁)=[u₂₁(t₂−5), u₂₁(t₂−6)], u₂₂(t₁)=[u₂₂(t₂−5), u₂₂(t₂−6)], y₁(t₁−1) is an actual value of nitrate nitrogen concentration at t₁−1, y₁(t₁−2) is an actual value of nitrate nitrogen concentration at t₁−2, u₂₁(t₂−5) is an aeration rate at t₂−5, u₂₁(t₂−6) is an aeration rate at t₂−6, u₂₂(t₂−5) is an internal reflux in WWTP at t₂−5, u₂₂(t₂−6) is an internal reflux in WWTP at t₂−6, T is a transpose of matrix, an output of the high-level FNN is a predicted value of nitrate nitrogen concentration ŷ₁(t₁) at t₁, an output expression is as follows:
$${\hat{y}}_{1} ( {t}_{1} ) = \frac{{\sum }_{j = 1}^{8} {w}_{hj} ( {t}_{1} ) {e}^{- {{\sum }^{ }}_{i = 1}^{6} \frac{{( {x}_{1 i} ( {t}_{1} ) - {c}_{hij} ( {t}_{1} ) )}^{2}}{2 {σ}_{hij}^{2} ( {t}_{1} )}}}{{\sum }_{j = 1}^{8} {e}^{- {{\sum }^{ }}_{i = 1}^{6} \frac{{( {x}_{1 i} ( {t}_{1} ) - {c}_{hij} ( {t}_{1} ) )}^{2}}{2 {σ}_{hij}^{2} ( {t}_{1} )}}} , \qquad ( 25 )$$
where x₁ᵢ(t₁) is ith input of the high-level FNN at t₁, wₕⱼ(t₁) is connection weight between jth neuron in a rule layer and an output neuron at t₁, j∈[1, 8], cₕᵢⱼ(t₁) is a center value of jth radial basal neuron corresponding to ith input neuron at t₁, i∈[1, 6], σₕᵢⱼ(t₁) is a center width of the ith input neuron corresponding to the jth radial basal neuron at t₁, e=2.72, parameter update rules are as follows:
wₕⱼ(t₁+1)=wₕⱼ(t₁)−0.2∂E₁(t₁)/∂wₕⱼ(t₁),
cₕᵢⱼ(t₁+1)=cₕᵢⱼ(t₁)−0.2∂E₁(t₁)/∂cₕᵢⱼ(t₁),
σₕᵢⱼ(tᵢ+1)=σₕᵢⱼ(t₁)−0.2∂E₁(t₁)/∂σₕᵢⱼ(t₁), (26)
where wₕⱼ(t₁+1) is a connection weight between the jth neuron in the rule layer and the output neuron at t₁+1, cₕᵢⱼ(t₁+1) is the center value of the jth radial basal neuron corresponding to the ith input neuron at t₁+1, σₕᵢⱼ(t₁+1) is the center width of the ith input neuron corresponding to the jth radial basal neuron at t₁+1, E₁(t₁)=½[y₁(t₁)−ŷ₁(t₁)]² is an error between an actual and a predicted nitrate nitrogen concentration at t₁;
3) set q=q+1, if q≤20 is true, go to step 2), otherwise, exit the cycle;
(4) the low-level FNN is designed to predict DO concentration at each sampling time t₂, which is as follows:
I set r=1;
II an input of the low-level FNN is x₂(t₂)=[y₂(t₂), u₂₁(t₂), u₂₂(t₂)]^{T}, y₂(t₂)=[y₂(t₂−1), y₂(t₂−2)], u₂₁(t₂)=[u₂₁(t₂−5), u₂₁(t₂−6)], u₂₂(t₂)=[u₂₂(t₂−5), u₂₂(t₂−6)], y₂(t₂−1) is an actual value of DO concentration at t₂−1, y₂(t₂−2) is an actual value of DO concentration at t₂−2, an output of the low-level FNN if the predicted value of DO concentration ŷ₂(t₂) at t₂, an output expression is as follows:
$${\hat{y}}_{2} ( {t}_{2} ) = \frac{{\sum }_{j = 1}^{8} {w}_{lj} ( {t}_{2} ) {e}^{- {{\sum }^{ }}_{i = 1}^{6} \frac{{( {x}_{2 i} ( {t}_{2} ) - {c}_{lij} ( {t}_{2} ) )}^{2}}{2 {σ}_{lij}^{2} ( {t}_{2} )}}}{{\sum }_{j = 1}^{8} {e}^{- {{\sum }^{ }}_{i = 1}^{6} \frac{{( {x}_{2 i} ( {t}_{2} ) - {c}_{lij} ( {t}_{2} ) )}^{2}}{2 {σ}_{lij}^{2} ( {t}_{2} )}}} , \qquad ( 27 )$$
where x₂ᵢ(t₂) is ith input of the low-level FNN at t₂, wₗⱼ(t₂) is a connection weight between the jth neuron in the rule layer and the output neuron at t₂, j∈[1, 8], cₗᵢⱼ(t₂) is the center value of the jth radial basal neuron corresponding to the ith input neuron at t₂, i∈[1, 6], σₗᵢⱼ(t₂) is the center width of the ith input neuron corresponding to the jth radial basal neuron at t₂, parameter update rules are as follows:
wₗⱼ(t₂+1)=wₗᵢ(t₂)−0.2∂E₂(t₂)/∂wₗⱼ(t₂),
cₗᵢⱼ(t₂+1)=cₗᵢⱼ(t₂)−0.2∂E₂(t₂)/∂cₗᵢⱼ(t₂),
σₕⱼ(t₂+1)=σₕⱼ(t₂)−0.2∂E₂(t₂)/σₕⱼ(t₂), (28)
where wₗⱼ(t₂+1) is the connection weight between the jth neuron in the rule layer and the output neuron at t₂+1, cₗᵢⱼ(t₂+1) is the center value of the jth radial basal neuron corresponding to the ith input neuron at t₂+1, σₗᵢⱼ(t₂+1) is the center width of the ith input neuron corresponding to the jth radial basal neuron at t₂+1, E₂(t₂)=¼[y₂(t₂)−ŷ₂(t₂)]², is the error between the actual and predicted DO concentration at t₂;
III set r=r+1, if r≤20 is true, go to step II, otherwise, exit the cycle;
(5) an optimization control module of HMPC module is designed as follows:
\textcircled{1} set k=0, m=0;
\textcircled{2} according to Eq.(1) and Eq.(3), the outputs of the high-level FNN ŷ₁(t₁) and the low-level FNN ŷ₂(t₂) are calculated respectively, ŷ₁(t₁)=[ŷ₁(t₁+1), ŷ₁(t₁+2), . . . , ŷ₁(t₁+5)]^{T}, ŷ₂(t₂)=ŷ₂(t₂+1), ŷ₂(t₂+2), . . . , ŷ₂(t₂+5)]^{T}, ŷ₁(t₁+1) is the predicted value of nitrate nitrogen concentration at t₁+1, ŷ₁(t₁+2) is the predicted value of nitrate nitrogen concentration at t₁+2, ŷ₁(t₁+5) is the predicted value of nitrate nitrogen concentration at t₁+5, ŷ₂(t₂+1) is the predicted value of DO concentration at t₂+1, ŷ₂(t₂+2) is the predicted value of DO concentration at t₂+2, ŷ₂(t₂+5) is the predicted value of DO concentration at t₂+5;
\textcircled{3} an objective function of high-level MPC is designed to track the set value of nitrate nitrogen concentration and DO concentration, and the high-level law at t₁ is calculated:
J₁(t₁)=λ₁[α₁eₚ₁(t₁)_{T}eₚ₁(t₁)+ρ₁Δu₁(t₁)^{T}Δu₁(t₁)]+λ₂[α₂eₚ₂(t₂)^{T}eₚ₂(t₂)+ρ₂Δu₁(t₁)^{T}Δu₁(t₁)], (29)
where eₚ₁(t₁)=r₁(t₁)−ŷ₁(t₁) is an error vector between the set value of nitrate nitrogen concentration at t₁ and the predicted value of nitrate nitrogen concentration, eₚ₁(t₁)=[eₚ₁(t₁+1), eₚ₁(t₁+2), . . . , eₚ₁(t₁+5)]^{T}, r₁(t₁)=[r₁(t₁+1), r₁(t₁+2), . . . , r₁(t₁+5)]^{T}, eₚ₁(t₁+1) is the error between the set value of nitrate nitrogen concentration and the predicted value of nitrate nitrogen concentration at t₁+1, eₚ₁(t₁+2) is the error between the set value of nitrate nitrogen concentration and the predicted value of nitrate nitrogen concentration at t₁+2, eₚ₁(t₁+5) is the error between the set value of nitrate nitrogen concentration and the predicted value of nitrate nitrogen concentration at t₁+5, r₁(t₁+1) is the set value of nitrate nitrogen concentration at t₁+1, r₁(t₁+2) is the set value of nitrate nitrogen concentration at t₁+2, r₁(t₁+5) is the set value of nitrate nitrogen concentration at t₁+5, eₚ₂(t₂)=r₂(t₂)−ŷ₂(t₂) is the error vector between the set value of DO concentration at t₂ and the predicted value of DO concentration, eₚ₂(t₂)=[eₚ₂(t₂+1), eₚ₂(t₂+2), . . . , eₚ₂(t₂+5)]^{T}, r₂(t₂)=[r₂(t₂+1), r₂(t₂+2), . . . , r₂(t₂+5)]^{T}, eₚ₂(t₂+1) is the error between the set value of DO concentration and the predicted value of DO concentration at t₂+1, eₚ₂(t₂+2) is the error between the set value of DO concentration and the predicted value of DO concentration at t₂+2, eₚ₂(t₂+5) is the error between the set value of DO concentration and the predicted value of DO concentration at t₂+5, r₂(t₂+1) is the set value of DO concentration at t₂+1, r₂(t₂+2) is the set value of DO concentration at t₂+2, r₂(t₂+5) is the set value of DO concentration at t₂+5, Δu₁(t₁)=[Δu₁₁(t₁), Δu₁₁(t₁)]^{T} is the control vector adjustment amount at t₁, Δu₁₁(t₁) is the adjustment amount of blower aeration at t₁, Δu₁₂(t₁) is the adjustment amount of internal reflux at t₁, λ₁=0.5, λ₂=0.5 are weight parameters, α₁=30, ρ₁=10, α₂=0.5, ρ₂=0.5 are control parameters, where
Δu₁(t₁)=u₁(t₁+1)−u₁(t₁),

|Δu₁(t₁)|≤Δuₘₐₓ, (30)
u₁(t₁)=[u₁₁(t₁), u₁₂(t₁)]^{T} is the control vector at t₁, u₁₁(t₁) is the aeration rate of the blower at t₁, u₁₂(t₁) is the internal reflux at t₁, u₁(t₁+1)=[u₁₁(t₁+1), u₁₂(t₁+1)]^{T} is the control vector at t₁+1, u₁₁(t₁+1) is the aeration rate of the blower at t₁+1, u₁₂(t₁+1) is the internal reflux flow at t₁+1, Δuₘₐₓ=[ΔK_{L}aₘₐₓ, ΔQₐₘₐₓ]^{T} is the maximum adjustment vector allowed by the controller, ΔK_{L}aₘₐₓ is the maximum aeration adjustment amount, ΔQₐₘₐₓ is the maximum internal reflux adjustment amount, Δuₘₐₓ is set through the blower and internal reflux valve in the control system equipment;
an aeration rate and internal reflux adjustment vector of the high-level MPC are calculated by minimizing Eq.(5):
$$Δ {u}_{1} ( {t}_{1} ) = {η}_{1} ( {{ξ}_{1} ( \frac{\partial {\hat{y}}_{1} ( {t}_{1} )}{\partial {u}_{1} ( {t}_{1} )} )}^{T} {e}_{p 1} ( {t}_{1} ) + {{ξ}_{2} ( \frac{\partial {\hat{y}}_{2} ( {t}_{2} )}{\partial {u}_{1} ( {t}_{1} )} )}^{T} {e}_{p 2} ( {t}_{2} ) ) , \qquad ( 31 )$$
where η₁=0.8, ξ₁=3, ξ₂=1 are control parameters to adjust the aeration rate and internal reflux at t₁:
u₁(t₁+1)=u₁(t₁)+Δu₁(t₁), (32)
\textcircled{4} an objective function of the low-level MPC is designed to track the concentration of DO and the control law calculated by the high-level controller, and the low-level control law is calculated at t₂;
J₂(t₂)=γ₁eₚ₂(t₂)²+γ₂[u₂₂(t₂)−u₁₂(t₁)]²+γ₃Δu₂(t₂)^{T}Δu₂(t₂), (33)
where u₂₂(t₂) is an internal reflux of the low-level MPC at t₂, u₁₂(t₁) is an internal reflux calculated by the high-level controller at t₁, Δu₂(t₂)=[Δu₂₁(t₂), Δu₂₂(t₂)]^{T} is a control vector adjustment amount at t₂, Δu₂₁(t₂) is a blower aeration adjustment amount at t₂, Δu₂₂(t₂) is an internal reflux adjustment amount at t₂, γ₁=30, γ₂=10, γ₃=1 are control parameters, where
Δu₂(t₂)=u₂(t₂+1)−u₂(t₂),

|Δu₂(t₂)|≤Δuₘₐₓ, (34)
where u₂(t₂)=[u₂₁(t₂), u₂₂(t₂)]^{T} is the control vector at t₂, u₂₁(t₂) is the aeration rate of the blower at t₂, u₂₂(t₂) is the internal reflux flow at t₂, u₂(t₂+1)=[u₂₁(t₂+1), u₂₂(t₂+1)]^{T} is the control vector at t₂+1, u₂₁(t₂+1) is the aeration rate of the blower at t₂+1, u₂₁(t₂+1) is the internal reflux flow at t₂+1;
the aeration rate and internal reflux adjustment vector of the low-level MPC are calculated by minimizing Eq.(9):
$$Δ {u}_{2} ( {t}_{2} ) = {η}_{2} [ {{γ}_{1} ( \frac{\partial {\hat{y}}_{2} ( {t}_{2} )}{\partial {u}_{2} ( {t}_{2} )} )}^{T} {e}_{p 2} ( {t}_{2} ) - {{γ}_{2} ( \frac{\partial {u}_{22} ( {t}_{2} )}{\partial {u}_{2} ( {t}_{2} )} )}^{T} ( {u}_{22} ( {t}_{2} ) - {u}_{12} ( {t}_{1} ) ) ] , \qquad ( 35 )$$
where η₂=8.4 is control parameter to adjust the aeration rate and internal reflux at t₂:
u₂(t₂+1)=u₂(t₂)+Δu₂(t₂), (36)
\textcircled{5} set k=k+1, if k=2(m+1) is true, set m=m+1 and go to step \textcircled{2}, otherwise, go to step \textcircled{6};
\textcircled{6} if k≤200 is true, calculate the output of the low-level FNN ŷ₂(t₂)=ŷ₂(t₂+1), ŷ₂(t₂+2), . . . , ŷ₂(t₂+5)]^{T} by Eq.(3), and go to step \textcircled{4}, otherwise, end the cycle;
(6) the concentration of nitrate nitrogen and DO is controlled by u₂(t₂) solved by the low-level controller, u₂(t₂)=[u₂₁(t₂), u₂₂(t₂)]^{T} is an input of a inverter and a sensor at t₂, the inverter controls the blower by adjusting a speed of a motor, and the sensor controls a valve by adjusting opening of an instrument, then, the aeration rate and internal reflux are controlled, the output of the system is the actual value of nitrate nitrogen concentration and DO concentration.
